(19) United States
(12) Patent Application Publication
(10) Pub. No.: US 2009/0125327 A1
(43) Pub. Date: May 14, 2009

(54) Systems And Methods For Voice Driven Health Data Tracker

(75) Inventors: Christine Peeters, Bartlett, IL (US); Catherine Lazatin, Palatine, IL (US); Kaushik Patel, Des Plaines, IL (US)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 11/937,327

(22) Filed: Nov. 8, 2007

(51) Int. Cl. G06Q 50/00; G06F 17/40; G06Q 10/00

(52) U.S. Cl. 705/3; 705/2

(57) ABSTRACT

Certain embodiments of the present invention provide a health data tracker system including a schedule component, a voice driven component, a data processor component, and a health data storage component. The schedule component is adapted to prompt a patient to input health data. The voice driven component is adapted to receive the health data from the patient. The data processor component is adapted to process the health data. The health data storage component is adapted to store the health data.

### BACKGROUND OF THE INVENTION

The present invention generally relates to tracking personal health. More specifically, the present invention relates to systems and methods for a voice driven health data tracker.

In current healthcare/clinical systems, healthcare practitioners may instruct patients to monitor certain health data. For example, patients may be required to record health data on a regular or semi-regular basis. Such health data may include vital signs, body weight, respiration rate, blood pressure, glucose level, heart rate, sugar levels, body temperature, food intake, fluid intake, and/or pain levels, for example. Patients may then periodically visit a healthcare practitioner to measure and record this data.

Health data may be stored in medical information systems, such as healthcare information systems (HIS), radiology information systems (RIS), clinical information systems (CIS), and cardiovascular information systems (CVIS), picture archiving and communication systems (PACS), library information systems (LIS), and electronic medical records (EMR). Information stored may also include medical records, patient medical histories, imaging data, test results, diagnosis information, scheduling information, insurance information, and/or contact information, for example. The information for a particular information system may be centrally stored or divided at a plurality of locations.

Several difficulties arise when patients record the health data without the aid of a healthcare practitioner. A patient may forget or not want to track his or her health data. A patient may record his or her health data on paper, but lose the notes or forget to bring them to a healthcare practitioner. A patient may track the wrong health data. For example, a patient may track his or her respiration rate instead of his or her heart rate. Current systems do not allow patients to monitor their health data effectively outside the presence of a healthcare practitioner.

If a patient visits a healthcare practitioner to record the data, the practitioner may then review the results to identify abnormal values. When a patient records the data without the aid of a practitioner, the patient may not know whether the values are abnormal. Industry-accepted clinically “normal” parameters or ranges may be used to identify data that may need further analysis. However, many patients may routinely have values that fall outside of the accepted norm. This may be due to a chronic condition, for example.

For example, the clinically-accepted fasting normal glucose reference range is 70-110 mg/dL. A diabetic patient, however, may consistently have glucose levels of 125 or higher. While this value falls out of the accepted normal range, most clinicians would find a value of 130 for this patient to be unremarkable because of the patient's chronic diabetes. However, a value of 200 would warrant concern and the clinician would desire to be alerted. Each individual patient may have a different range for a particular health data type.

### BRIEF SUMMARY OF THE INVENTION

Certain embodiments of the present invention provide a health data tracker system including a schedule component, a voice driven component, a data processor component, and a health data storage component. The schedule component is adapted to prompt a patient to input health data. The voice driven component is adapted to receive the health data from the patient. The data processor component is adapted to process the health data. The health data storage component is adapted to store the health data.

Certain embodiments of the present invention provide a health data tracking method including prompting a patient to input health data, receiving the health data in response to voice commands of the patient, processing the health data, and storing the health data.

Certain embodiments of the present invention provide a health data tracker system including a voice driven component, a data processor component, a health data storage component, and an alert component. The voice driven component is adapted to receive health data from a patient. The data processor component is adapted to process the health data. The health data storage component is adapted to store the health data. The alert component is adapted to alert the patient based at least in part on a comparison of the health data to at least one health data parameter.

### BRIEF DESCRIPTION OF SEVERAL VIEWS OF THE DRAWINGS

FIG. 1 illustrates a health data information system according to an embodiment of the present invention.

FIG. 2 illustrates a health data tracker system according to an embodiment of the present invention.

FIG. 3 illustrates a health data information system according to an embodiment of the present invention.

FIG. 4 illustrates a flow diagram for a voice driven health data tracking method in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

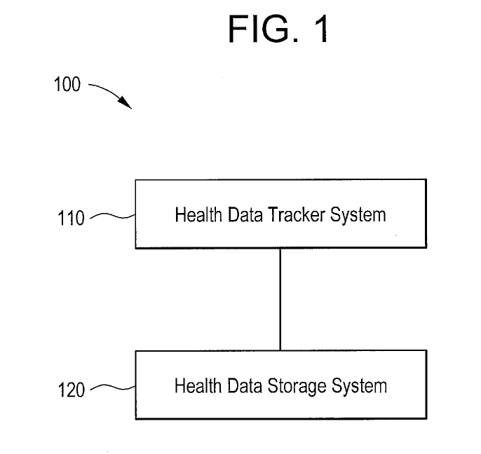

FIG. 1 illustrates a health data information system 100 according to an embodiment of the present invention. The system 100 includes a health data tracker system 110 and a health data storage system 120. The health data tracker system 110 is in communication with the health data storage system 120.

In operation, the health data tracker system 110 is adapted to receive health data from a user, process the health data, store the health data, and transmit the health data to the health data storage system 120. The user may be a patient, someone assisting a patient, or a healthcare practitioner, for example.

The health data may include vital signs, body weight, respiration rate, blood pressure, glucose level, heart rate, sugar levels, body temperature, food intake, fluid intake, pain levels, images of a wound area, images of a surgical site, audio recordings of a patient's breathing, and/or videos of a patient, for example.

The health data may be inputted and stored in a variety of formats. For example, health data may be audio health data, text health data, video health data, or image health data. Audio health data is health data in an audio format, such as a .wav, .au, .ogg, .m4a, .wma, or .mp3 format, for example. Text health data is health data in a text format, such as a .txt, .rtf, or .doc format, for example. Video health data is health data in a video format, such as an .mp4, .mov, .mpeg, .avi, or .wmv format, for example. Image health data is health data in an image format, such as a .jpg, .tif, .raw, .png, or .gif format, for example.

Depending on the format of the health data, the health data tracker system 110 may not need to process the health data. For example, the health data tracker system 110 may need to process audio health data by converting it into text, but may not need to process text health data. As another example, the health data tracker system 110 may need to process video health data by extracting the audio health data in the video and converting the audio health data into text.

The health data tracker system 110 may communicate with the health data storage system 120 using wired or wireless connections. For example, the systems may communicate utilizing the Internet, a public telephone network, a dedicated communication line, a virtual private network (VPN), a secure network, and/or an intranet. The systems also may follow a selected protocol to communicate, such as hypertext transfer protocol (HTTP), file transfer protocol (FTP), transmission control protocol/internet protocol (TCP/IP), .NET protocol, or Java protocol, for example.

The health data tracker system 110 may be integrated into a portable device, such as a cell phone, a personal digital assistant (PDA), a laptop computer, or a tablet personal computer, for example. In some embodiments, the health data storage system 120 is a separate module. That is, the health data storage system 120 is a stand-alone device.

The health data storage system 120 may include at least one of a medical information system and a storage system. In certain embodiments, the health data storage system 120 may include a server in communication with at least one of a medical information system and a storage system, wherein each system may store health data. In other embodiments, the health data storage system 120 may include a series of networked servers.

In certain embodiments, the health data tracker system 110 may transmit patient data to the health data storage system 120 in addition to the health data. The patient data may include at least one of a patient name, a patient identification number, a patient age, a patient gender, and a patient race, for example. The health data tracker system 110 may also transmit the time and date the system 110 received the health data.

In certain embodiments, the health data tracker system 110 may be in communication with a computer. The health data tracker system 110 may have a port, such as universal serial bus (USB) port, for example, whereby the user may connect the health data tracker system 110 to a computer with a port, such as a USB port, for example. If the computer has access to the health data tracker system 120, through the Internet, for example, the user may upload the data, such as the health data and the patient data, from the health data tracker system 110 to the health data storage system 120 using known methods of data transfer. Alternatively, the health data tracker system 110 may communicate with the computer wirelessly, using bluetooth or infrared technology, for example, to allow the user to upload the data to the health data storage system 120. In certain embodiments, the processing is done by a computer application rather than the health data tracker system 110.

In the embodiments where the health data tracker system 110 is in communication with the computer, the computer may display the health data using software on the computer. For example, the computer may display the health data using Microsoft Excel. The user may analyze the health data on the computer. For example, the user may look for trends in the health data using Microsoft Excel.

The user may use the computer to store the health data and the patient data on portable media. For example, the computer may include a magnetic disk drive for writing to a removable magnetic disk and/or an optical disk drive for writing to a removable optical disk such as a CD ROM or other optical media. As another example, the computer may include a USB port to which a USB storage device may be attached. The user may store the health data and the patient data on the removable magnetic disk, the removable optical disc, or the USB storage device, for example. The user may bring the health data tracker system 110 or the portable media with the stored health data and patient data to a healthcare practitioner. The healthcare practitioner may examine the health data.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

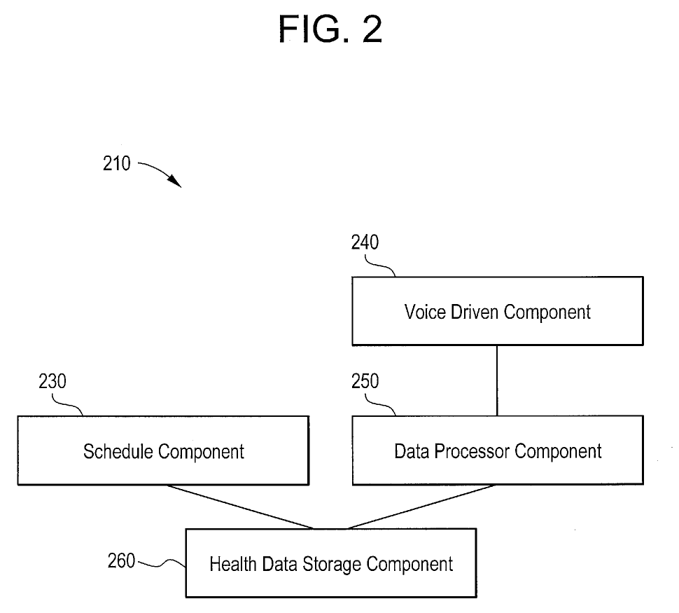

FIG. 2 illustrates a health data tracker system 210 according to an embodiment of the present invention. The health data tracker system 210 may be similar to the health data tracker system 110 described above, for example. The system 210 includes a schedule component 230, a voice driven component 240, a data processor component 250, and a health data storage component 260.

The schedule component 230 is in communication with the health data storage component 260. The voice driven component 240 is in communication with the data processor component 250. The data processor component 250 is in communication with the health data storage component 260.

In operation, the schedule component 230 is adapted to retrieve scheduled prompts from the health data storage component 260. A scheduled prompt may include a date and time scheduled by a healthcare practitioner, a patient, or someone assisting a patient, for example. The schedule component 230 is also adapted to prompt a user to input health data at or near the dates and times indicated by the scheduled prompts. The voice driven component 240 is adapted to receive commands and health data from the user. The data processor component 250 is adapted to process the commands and the health data from the voice driven component 240. The health data storage component 260 is adapted to store the health data. The user may be a patient, someone assisting a patient, or a healthcare practitioner, for example.

In certain embodiments, the voice driven component 240 is integrated with the data processor component 250. In certain embodiments, the data processor component 250 is integrated with the health data storage component 260. In certain embodiments, the schedule component 230 is integrated with the health data storage component 260. In certain embodiments, the schedule component 230, the voice driven component 240, the data processor component 250, and the health data storage component 260 may each include a separate module in the health data tracker system 210. The components may communicate via wired or wireless methods.

The health data may be similar to the health data described above in reference to FIG. 1.

Audio health data may be inputted via the voice driven component 240.

The health data tracker system 210 may also include a user interface component. The user may utilize the user interface component to input commands, text health data, video health data, or image health data, for example. The user interface component may include any component capable of communicating information to or receiving information from the user. For example, the user interface component may include a display screen, a QWERTY keyboard, a number pad, a mouse, a scroll ball, a scroll wheel, a trackball, a touchpad, a graphics tablet and a stylus, a barcode reader, a speaker, a vibration component, and/or a digital camera.

A user may input a command into the health data tracker system 210 via the user interface component or the voice driven component 240. A command inputted through the voice driven component 240 is a voice command.

The scheduled prompt may indicate when the health data tracker system 210 should remind a user to input the patient's health data. The prompt may also indicate the health data type the user is to input, such as blood pressure, for example. Additionally, the prompt may indicate the type of prompt the health data tracker system 210 is to generate, such as a written message on a display, an audible message, and/or a vibration, for example.

The voice driven component 240 transmits received voice commands and audio health data to the data processor component 250.

The data processor component 250 is adapted to receive the voice commands and the audio health data from the voice driven component 240. The data processor component 250 may employ voice-to-text software or voice-recognition software to identify the voice commands. For example, the data processor component 250 may convert the voice commands to text and identify which command the user inputted.

The data processor component 250 is adapted to implement the identified voice commands. For example, the data processor component 250 may follow a programmed set of instructions specific to each identified command. In certain embodiments, the data processor component 250 may also be adapted to receive commands and health data from the user interface component.

The data processor component 250 may notify the user about commands which are unidentified. For example, the data processor component 250 may transmit a signal to the user interface component causing the user interface component to display or audibly emit a message telling the user the command is not recognized. The user interface component may then prompt the user to input another command.

The data processor component 250 may also be adapted to process the health data. For example, the data processor component 250 may employ the voice-to-text or text-recognition software to convert audio health data into text health data. The data processor component 250 may transmit the health data to the health data storage component 260 in a variety of formats. For example, the data processor component 250 may process and transmit audio health data, text health data, video health data, and image health data. The health data storage component 260 may store the heath data in those formats.

The health data storage component 260 may also store patient data. The patient data may be similar to the patient data described above in reference to FIG. 1. Audio patient data is patient data in an audio format, such as a .wav, .ogg, .m4a, .wma, or .mp3 format, for example. The user may input audio patient data into the health data tracker system 210 using the voice driven component 240. The voice driven component 240 may transmit the audio patient data to the data processor component 250. The data processor component 250 may process the audio patient data by converting the audio patient data into text. Text patient data is patient data in a text format, such as a .txt, .rtf, or .doc format, for example. The data processor component 250 may transmit the text patient data to the health data storage component 260 for storage.

Alternatively, the user may input the patient data into the health data tracker system 210 using the user interface component. The user interface component may transmit the patient data to the data processor component 250. The data processor component 250 may transmit the patient data to the health data storage component 260 for storage.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

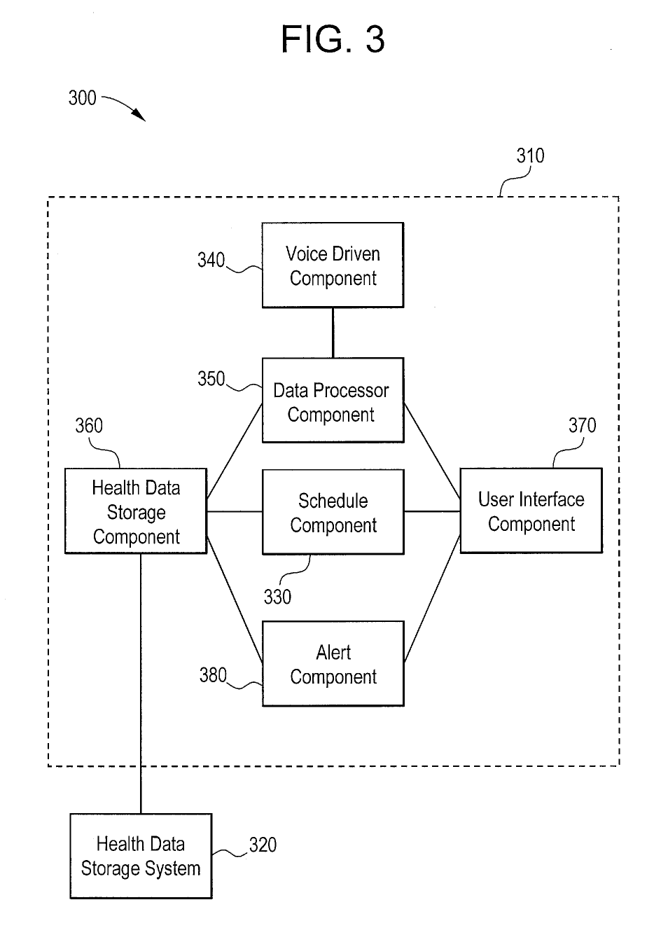

FIG. 3 illustrates a health data information system 300 according to an embodiment of the present invention. The system 300 includes a health data tracker system 310 and a health data storage system 320. The health data tracker system 310 includes a schedule component 330, a voice driven component 340, a data processor component 350, a health data storage component 360, a user interface component 370, and an alert component 380.

The health data storage component 360 of the health data tracker system 310 is in communication with the health data storage system 320. The health data storage component 360 is also in communication with the schedule component 330, the data processor component 350, and the alert component 380. The user interface component 370 is in communication with the schedule component 330, the data processor component 350, and the alert component 380. The voice driven component 340 is in communication with the data processor component 350.

In operation, the health data storage system 320 and the health data storage component 360 are adapted to store scheduled prompts, health data alert parameters, health data, and patient data, for example. The health data storage system 320 is adapted to receive health data and patient data from and to transmit scheduled prompts and health data alert parameters to the health data storage component 360. The health data storage component 360 is adapted to receive scheduled prompts and health data alert parameters from and to transmit health data and patient data to the health data storage system 320.

The schedule component 330 is adapted to retrieve scheduled prompts from the health data storage component 360. The scheduled prompts may be similar to the scheduled prompts discussed above in reference to FIG. 2. The schedule component 330 is also adapted to prompt a user to input health data at or near the dates and times indicated by the scheduled prompts.

The voice driven component 340 is adapted to receive voice commands and audio health data from the user. The user interface component 370 is also adapted to receive commands and health data from the user. The data processor component 350 is adapted to process the commands and health data received by the voice driven component 340 and the user interface component 370. The user may be a patient, someone assisting a patient, or a healthcare practitioner, for example.

The user may input patient data into the health data tracker system 310 using the voice driven component 340 or the user interface component 370. The patient data may be similar to the patient data discussed above in reference to FIGS. 1 and 2. The voice driven component 340 and the user interface component 370 may transmit the patient data to the data processor component 350. If the patient data is audio patient data, the data processor component 350 may convert audio patient data into text patient data using voice-recognition software or voice-to-text software. The data processor component 350 may transmit the patient data to the health data storage component 360 for storage.

In certain embodiments, the voice driven component 340 is integrated with the data processor component 350. In certain embodiments, the data processor component 350 is integrated with the health data storage component 360. In certain embodiments, the schedule component 330 is integrated with the health data storage component 360. In certain embodiments the user interface component 370 is integrated with the data processor component 350. In certain embodiments, the user interface component 370 is integrated with the schedule component 330. In certain embodiments the user interface component 370 is integrated with the alert component 380. In certain embodiments the data storage component 360 is integrated with the alert component 380. In certain embodiments, the schedule component 330, the voice driven component 340, the data processor component 350, the health data storage component 360, the user interface component 370, and the alert component 380 may each include a separate module in the health data tracker system 310.

The components of the health data tracker system 310 may communicate via wired or wireless methods.

The health data tracker system 310 may be similar to the health data tracker system 110 and the health data tracker system 210 described above. The health data storage system 320 may be similar to the health data storage system 120 described above. The schedule component 330 may be similar to the schedule component 230 described above. The voice driven component 340 may be similar to the voice driven component 240 described above. The data processor component 350 may be similar to the data processor component 250 described above. The health data storage component 360 may be similar to the health data storage component 260 described above. The user interface component 370 may be similar to the user interface component of the health data tracker system 210 described above.

A scheduled prompt may indicate a date and time when the health data tracker system 310 should remind a user to input health data. In an embodiment, a healthcare practitioner may input at least one scheduled prompt into the health data storage system 320. The health data storage system 320 may transmit the at least one scheduled prompt to the health data storage component 360. The health data storage component 360 may store the at least one scheduled prompt. The schedule component 330 may track the at least one scheduled prompt stored in the health data storage component 360.

When the date and time in a stored scheduled prompt occurs, the schedule component 330 may transmit a signal to the user interface component 370 to prompt the user. The user interface component 370 may prompt the user through a variety of mechanisms. The scheduled prompt may indicate which type of prompt the user interface component 370 should use. For example, the user interface component 370 may vibrate, display a message reminding the user to input health data, and/or audibly emit a message reminding the user to input health data. The scheduled prompt may also indicate the health data type the user interface component 370 should prompt the user to input. For example, the scheduled prompt may indicate the user is to input the patient's blood pressure. The user interface component 370 may then prompt the user to input the patient's blood pressure.

A health data alert parameter may be a health data value associated with a certain health data type. More than one health data alert parameter may include a health data alert range. For example, a health data alert range for a patient's respiratory rate may be between 12 and 20 breaths per minute.

A healthcare practitioner or a patient may input a health data alert parameter into the health data tracker system 310 using the voice driven component 340, the user interface component 370, or the health data storage system 320. The voice driven component 340 and the user interface component 370 may transmit the health data alert parameter to the data processor component 350. The data processor component 350 may process the health data alert parameter. For example, the data processor component 350 may use voice-to-text software or voice-recognition software to convert a health data alert parameter inputted received from the voice driven component 340 to text. The data processor component 350 may transmit the health data alert parameter to the health data storage component 360. The health data storage component 360 may store the health data alert parameter. Alternatively, the health data storage system 320 may transmit the health data alert parameter to the health data storage component 360 for storage.

The user may speak a voice command into the voice driven component 340. The voice driven component 340 may transmit the voice command to the data processor component 350. The data processor component 350 may use voice-to-text software or voice-recognition software to identify which voice command the user has input into the voice driven component 340. Alternatively, the user may input a command using the user interface component 370, which may then transmit the command to the data processor component 350.

If the data processor component 350 cannot identify the command received from the voice driven component 340 or the user interface component 370, the data processor component 350 may transmit a signal to the user interface component 370. The signal may cause the user interface component 370 to display or audibly emit a message informing the user that the system cannot identify the command and requesting that the user input the command again.

If the data processor component 350 identifies the command, the data processor component 350 may then follow a programmed set of instructions. For example, if the command is “turn on,” the data processor component 350 may turn on the health data tracking system 310. If the command is that the user is going to input a certain health data type, the data processor component 350 may process the next health data entered into the voice driven component 340 or the user interface component 370, and transmit the health data and the health data type to the health data storage component 360. If the health data is audio health data, the data processor component 350 may use voice-to-text software or voice-recognition software to convert the audio health data to text health data.

For example, the user may say “inputting blood pressure” or input a command on the user interface component 370 telling the health data tracker system 310 that the user is “inputting blood pressure.” The next health data inputted into the voice driven component 340 or the user interface component 370 may be processed and stored as blood pressure health data.

In certain embodiments, the data processor component 350 may transmit a signal to the user interface component 370 to ask the user to verify that the inputted health data and health data type are correct. The user may respond using the voice driven component 340 or the user interface component 370. If the user indicates the health data and the health data type are correct, the data processor component 350 may transmit the health data and the health data type to the health data storage component 360. If the user indicates the health data is incorrect, the user interface component 370 may request that the user input the health data again. If the user indicates the health data type is incorrect, the user interface component 370 may request that the user input another command.

Additionally, the data processor component 350 may also include a clock component. The data processor component 350 may transmit the date and time when the user inputted the health data to the health data storage component 360.

The health data storage component 360 may transmit newly stored health data and at least one health data alert parameter for the same health data type to the alert component 380. The alert component 380 is adapted to compare the newly stored health data and the at least one health data alert parameter.

In certain embodiments, the alert component 380 may compare health data to at least one health data alert parameter for the same health data type upon the occurrence of a variety of different events, such as the entry of the health data, the storing of the health data, and/or the sending of the health data to the health data storage system 320, for example. In some embodiments, the alert component 380 may compare the health data to the at least one health data alert parameter periodically.

The health data alert parameter may indicate whether the parameter is an upper threshold or a lower threshold. If the health data alert parameter is an upper threshold and the newly stored health data is above the health data alert parameter, then the alert component 380 may transmit an alert to the user interface component 370. If the health data alert parameter is a lower threshold and the newly stored health data is below the health data alert parameter, then the alert component 380 may transmit an alert to the user interface component 370.

The user interface component 370 may then output the alert by displaying the alert as a message on the display screen, operating the vibration component, and/or emitting an audible message containing the alert, for example. If the health data alert parameter is an upper threshold, the alert may indicate that the patient's health data is above a recommended health data alert parameter for that particular health data type. If the health data alert parameter is a lower threshold, the alert may indicate that the patient's health data is below a recommended health data alert parameter for that particular health data type. The health data alert parameter may also indicate the type of alert the user interface component 370 should output. For example, the health data alert parameter may indicate that the alert should instruct the patient to seek medical attention.

As an example, the upper threshold health data alert parameter for blood pressure may be “120/80.” If the newly stored health data for blood pressure is “140/90,” the alert component 380 may transmit an alert to the user interface component 370. The user interface component 370 may display a message that the patient's blood pressure is higher than recommended.

The alert component 380 also may compare the newly stored health data to a health data alert range for the same health data type. The health data alert range includes at least one upper threshold and at least one lower threshold health data alert parameter.

As an example, the health data alert range for blood pressure may be any reading outside of “90/60” and “120/80.” If the newly stored health data for blood pressure is “140/90,” the alert component 380 may transmit an alert to the user interface component 370. The user interface component 370 may display a message that the patient's blood pressure is outside the recommended range.

In certain embodiments, the alert component 380 may also transmit the alert to the health data storage system 320. The health data storage component 360 may store the alert. The health data storage component 360 may also be adapted to transmit the stored alert and the patient data to the health data storage system 320. The health data storage system 320 may transmit the alert and the patient data to a healthcare practitioner or a “911 Call Center,” for example.

The user interface component 370 also may allow a user to select which health data, health data alert parameters, patient data, and scheduled prompts to display on the user interface component 370. The user interface component 370 may display the selected health data, the selected health data alert parameters, the patient data, and the selected scheduled prompts.

In certain embodiments, the health data tracker system 310 may allow the user to change the health data alert parameters, the patient data, the scheduled prompts, and the health data stored in the health data storage component 360 by inputting commands into the voice driven component 340 and/or the user interface component 370.

The health data storage component 360 also may transmit the stored health data and the patient data to the health data storage system 320. The transmission may take place when the health data storage component 360 stores the health data, when changes are made to the stored health data, and/or at regular intervals, for example.

In certain embodiments, the user may have to measure or determine the health data using at least one independent medical device before inputting the health data into the health data tracker system 310. For example, the user may use a blood pressure monitor to determine the user's or a patient's blood pressure. The at least one independent medical device may be in communication with the health data tracker system 310. The at least one independent medical device may transmit the health data and the health data type to the health data tracker system 310. In certain embodiments, at least one independent medical device is incorporated into the health data tracker system 310. For example, the health data tracker system 310 also may include a blood pressure monitor.

In certain embodiments, the health data tracker system 310 may also include a global positioning component capable of outputting the location of the system 310. In those embodiments, the global positioning component may be in communication with or integrated into the health data storage component 360. The health data storage component 360 may transmit the patient data and the location of the health data tracker system 310 to the health data storage system 320. The health data storage system 320 may also be adapted to transmit the patient data and the location of the health data tracker system 310 to a healthcare practitioner or a “911 Call Center,” for example.

It will be understood that, in certain embodiments, a health data tracker system 310 may track more than one patient's health data. In those embodiments, the health data storage component 360 may store patient data for each patient. Accordingly, each patient's patient data may be associated with that patient's health data.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

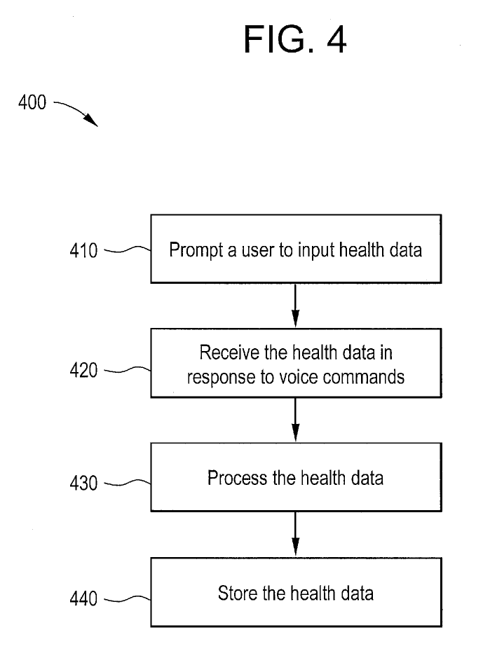

FIG. 4 illustrates a flow diagram for a voice driven health data tracking method 400 in accordance with an embodiment of the present invention. The method 400 includes the following steps, which will be described below in more detail. At step 410, a health data tracker system prompts a user to input health data. At step 420, the health data tracker system receives the health data in response to voice commands of the user. At step 430, a data processor component of the health data tracker system processes the health data. At step 440, a health data storage component of the health data tracker system stores the health data. The method 400 is described with reference to elements of systems described above, but it should be understood that other implementations are possible.

At step 410, the health data tracker system prompts the user to input the health data. The health data tracker system and its components may be similar to the health data tracker system 310 and its components described above. A schedule component of the health data tracker system may read and track scheduled prompts stored in the health data storage component. The scheduled prompts may be similar to the scheduled prompts described above in reference to FIGS. 2 and 3. When a date and time in a stored scheduled prompt occurs, the schedule component may transmit a signal to a user interface component of the health data tracker system. The signal may cause the user interface component to prompt the user to input the health data.

The user interface component may prompt the user through a variety of mechanisms. The scheduled prompt may indicate which type of prompt the user interface component should use. For example, the user interface component may vibrate, display a message reminding the user to input health data, and/or audibly emit a message reminding the user to input health data. The scheduled prompt may also indicate the health data type the user interface component should prompt the user to input. For example, the scheduled prompt may indicate the user is to input the patient's blood pressure. The user interface component may then prompt the user to input the patient's blood pressure.

At step 420, the health data tracker system receives the health data in response to the voice commands of the user. A voice driven component of the health data tracker system is adapted to receive voice commands and audio health data from the user. The user may speak the voice commands into the voice driven component. The voice driven component may transmit the voice commands to the data processor component. The data processor component may use voice-to-text software or voice-recognition software to identify which voice command the user has input into the voice driven component. If the data processor component cannot identify the voice command, the user interface component may display or audibly emit a message informing the user that the system cannot identify the command and requesting that the user input the command again.

The user may also input the command using the user interface component. For example, the user may type in the command using a QWERTY keyboard on the user interface component.

If the data processor component identifies the command, the data processor component may then follow a programmed set of instructions. For example, if the voice command is that the user is going to input a certain health data type, the user may then input the health data using either the user interface component or the voice driven component. The component that receives the health data transmits it to the data processor component.

For example, the user may say “inputting blood pressure.” In certain embodiments, the user interface component may either display or audibly emit a message telling the user that “the system is ready to receive health data for blood pressure.” The user may then speak “115 over 84” into the voice driven component or input the “115/84” into the user interface component. The voice driven component or the user interface component may then transmit the received health data to the data processor component.

At step 430, the data processor component processes the health data. The data processor component receives the health data either from the voice driven component or the user interface component. The data processor component may convert the health data to another format, such as text, or leave the health data in the format the data processor component received it. For example, if the voice driven component transmits audio health data to the data processor component, the data processor component may convert the audio health data to text using speech-to-text software or voice-recognition software in current use. The data processor component may transmit the health data to the health data storage component for storage.

In certain embodiments, the scheduled prompt, which the schedule component used to prompt the user, may indicate the preferred storage format for the health data. The data processor component may convert the health data inputted into the health data tracker system to the preferred storage format. For example, the schedule component may prompt the user to input blood pressure. The user may say “inputting blood pressure” or input a command on the user interface component telling the health data tracker system that the user is “inputting blood pressure.” If the scheduled prompt indicated that the blood pressure health data is to be stored in a text format, the data processor component may convert the inputted health data into text, if necessary.

If the data processor component cannot convert the health data to the preferred storage format, the data processor component may store the health data in the format it is already in and/or display a message to the user that the user needs to input the health data in a format convertible to the preferred storage format. For example, if the preferred storage format is text health data and the user inputs video health data, the data processor component may not be able to convert the video health data to text. The health data tracker system may then display a message on the user interface component that the user must input the health data in a text or audio format.

At step 440, the health data storage component stores the health data. The data processor component transmits the health data to the health data storage component to be stored. The data processor component may also transmit the health data type. Additionally, the data processor component may transmit to the health data storage component the date and time when the user inputted the health data. The health data storage component may store health data in a variety of formats, including audio health data, text health data, video health data, and image health data, for example.

In certain embodiments, the method 400 may include an additional step where an alert component of the health data tracker system compares the newly stored health data to at least one health data alert parameter. The health data storage component may transmit the newly stored health data and the at least one health data alert parameter for the same health data type to the alert component. The alert component may compare the newly stored health data to the at least one health data alert parameter.

The health data alert parameter may be similar to the health data alert parameter described above in reference to FIG. 3. If the newly stored health data is above an upper threshold health data alert parameter, then the alert component may transmit an alert to the user interface component. If the newly stored health data is below a lower threshold health data alert parameter, then the alert component may transmit an alert to the user interface component.

The user interface component may then output the alert by displaying the alert as a message on the display screen, operating the vibration component, and/or emitting an audible message containing the alert, for example. If the health data alert parameter is an upper threshold, the alert may indicate that the patient's health data is above a recommended health data alert parameter for that particular health data type. If the health data alert parameter is a lower threshold, the alert may indicate that the patient's health data is below a recommended health data alert parameter for that particular health data type.

In certain embodiments, the method 400 may include an additional step where the alert component of the health data tracker system compares the newly stored health data to a health data alert range for the same health data type. The health data alert range includes at least one upper threshold and at least one lower threshold health data alert parameter.

In certain embodiments, the method 400 may include an additional step where the alert component analyzes the health data alert parameters, the health data, and other factors, such as the patient data. For example, if the alert component is analyzing recently stored blood pressure health data, the alert component may issue an alert if the stored health data is “130/80” and the patient data indicates the patient age is 29. However, if the stored health data is “130/80” and the patient data indicates the patient age is 65, the alert component may not transmit an alert, for example.

In certain embodiments, the step 410 may include prompting the user to input an image. For example, the schedule component may prompt the user to input an image of a surgical site. In such embodiments, at step 420, the user may say “inputting image of the surgical site” or input a command on the user interface component telling the health data tracker system that the user is “inputting image of the surgical site.” The user interface component may also include a digital camera. The user may use the digital camera to capture an image of the surgical site. In such embodiments, at step 430, the user interface component may transmit the image to the data processor component. The data processor component may transmit to the health data storage component the image health data, the health data type (image of surgical site), and the date and time the image was captured. In such embodiments, at step 440, the health data storage component may store the health data as image health data, along with the date and time the image was captured.

In certain embodiments, the method 400 may include an additional step wherein the health data storage component transmits the stored health data to a health data storage system. The health data storage system may be similar to the health data storage system 120 and the health data storage system 320 described above. The health data storage component may transmit the stored health data, the patient data, and/or the dates and times the user inputted the health data to the health data storage system.

In certain embodiments, the method may include a step wherein the alert component transmits the alert to the health data storage component. The health data storage component may store the alert along with the date and time of the alert. The health data storage component may also be adapted to transmit the alert, the date and time of the alert, and the patient data to the health data storage system.

In certain embodiments, the method may include a step wherein the alert component transmits the alert to a healthcare practitioner. For example, after receiving the information as described above, the health data storage system may transmit the alert, the date and time of the alert, and the patient data to a healthcare practitioner or a “911 Call Center.”

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processor device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide systems and methods for a voice driven health data tracker. Certain embodiments provide a technical effect of voice driven health data tracking.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN), which are presented here by way of example and not limitation. Such networking environments are commonplace in office-wide or enterprise-wide computer networks, intranets, and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules, and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any voice driven health data tracker. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A health data tracker system, the system comprising:
a schedule component adapted to prompt a patient to input health data;
a voice driven component adapted to receive the health data from the patient;
a data processor component adapted to process the health data; and
a health data storage component adapted to store the health data.

2. The system of claim 1, wherein the health data storage component is adapted to transmit the health data to a health data storage system.

3. The system of claim 2, wherein the health data storage component is adapted to store patient data, and wherein the health data storage component is further adapted to transmit the patient data to the health data storage system.

4. The system of claim 1, further comprising an alert component adapted to alert the patient based at least in part on a comparison of the health data to at least one health data parameter.

5. The system of claim 4, wherein the alert component is adapted to transmit an alert to a health data storage system based at least in part on the comparison of the health data to the at least one health data parameter.

6. The system of claim 1, wherein the received health data is audio health data.

7. The system of claim 1, wherein the received health data is image health data.

8. The system of claim 1, wherein the health data storage component is adapted to receive scheduled prompts from a health data storage system, and wherein the schedule component is adapted to retrieve the scheduled prompts from the health data storage component.

9. A health data tracking method, the method comprising:
prompting a patient to input health data;
receiving the health data in response to voice commands of the patient;
processing the health data; and
storing the health data.

10. The method of claim 9, further comprising transmitting the stored health data to a health data storage system.

11. The method of claim 9, further comprising alerting the patient based at least in part on a comparison of the stored health data to at least one health data parameter.

12. The method of claim 11, further comprising setting the at least one health data parameter.

13. The method of claim 9, further comprising alerting a healthcare practitioner based at least in part on a comparison of the stored health data to at least one health data parameter.

14. The method of claim 9, further comprising scheduling a prompt for the health data.

15. The method of claim 9, further comprising displaying the health data.

16. The method of claim 9, wherein the received health data is audio health data.

17. The method of claim 16, wherein the processing step further comprises converting the received health data to text health data.

18. The method of claim 9, wherein the received health data is image health data.

19. A health data tracker system, the system comprising:
a voice driven component adapted to receive health data from a patient;
a data processor component adapted to process the health data;
a health data storage component adapted to store the health data; and
an alert component adapted to alert the patient based at least in part on a comparison of the health data to at least one health data parameter.

20. The system of claim 19, wherein the health data storage component is adapted to transmit the health data to a health data storage system.
